(19) United States
(12) Patent Application Publication
(10) Pub. No.: US 2007/0266131 A1
(43) Pub. Date: Nov. 15, 2007

(54) Obtaining and Using Primary Access Numbers Utilizing a Mobile Wireless Device

(75) Inventors: Arie Mazur, Toronto (CA); Vadim Fux, Waterloo (CA)

Correspondence Address: PATENT ADMINISTRATOR;KATTEN MUCHIN ROSENMAN LLP, 1025 THOMAS JEFFERSON STREET, N.W., EAST LOBBY: SUITE 700, WASHINGTON, DC, 20007-5201, US

(73) Assignee: Simpera Inc., Toronto (CA)

(21) Appl. No.: 11/383,082

(22) Filed: May 12, 2006

(51) Int. Cl. G06F 15/173

(52) U.S. Cl. 709/223; 705/26

(57) ABSTRACT

The present invention relates to a system and method for obtaining and using primary access numbers on a wireless mobile device. This is accomplished through the use of a mobile client stored on the mobile wireless device. The mobile client being connected via a wireless network to a system server, the server providing primary access numbers for purchases and reconciling a purchase using a primary access number with a financial institution, a merchant or a third party. In alternative embodiment the merchant may connect directly with the financial institution, bypassing the system server.

### BACKGROUND OF THE INVENTION

The use of mobile wireless devices such as mobile phones, personal digital assistants, laptops and other computing devices is growing rapidly throughout the world. These devices are also providing greater functionality with increasing computing power. Many applications have been developed to make use of mobile wireless devices including accessing the Internet, which allows the user much of the functionality of a traditional wired system. With this ability to access the Internet, and other networks, it is possible for a mobile wireless device to become an integral part of commerce aiding the process of purchasing goods and services.

By way of a specific form of transaction, a mobile wireless device provides the ability to purchase items and services using the existing infrastructure of electronic banking for Card Not Present (CNP) transactions. The system making this possible is described in this disclosure. Specifically the creation and delivery of a Primary Access Number (PAN) for a limited time usage, where the funds available via the PAN are the funds in a user account in the name of the user in the system. The system described also provides for the purchase and usage of tokens through Near Field Communication (NFC) with a wireless mobile device and a terminal. Further the system described also provides for the topping up of a third party account, for example an account for the usage of the mobile wireless device.

### SUMMARY OF THE INVENTION

The present invention is directed to a method for obtaining and utilizing a PAN to conduct a monetary transaction between a first party and a second party through the use of a mobile wireless device comprising the steps of:

providing to said first party a temporary PAN from a block of PANs obtained from an issuer;

said first party providing said temporary PAN to said second party;

said second party contacting said issuer to verify said temporary PAN;

said issuer contacting a system server to confirm the validity of said monetary transaction based on said temporary PAN; and

if said system server confirms the validity of said monetary transaction, informing said first party and said second party of the result of said transaction and reconciling the transfer of payment between said first party and said second party if the result is positive.

The present invention is also directed to a system for obtaining and utilizing a PAN to conduct a monetary transaction between a first party and a second party through the use of a mobile wireless device comprising:

means for providing to said first party a temporary PAN from a block of PANs obtained from an issuer;

means for said first party providing said temporary PAN to said second party;

means for said second party contacting said issuer to verify said temporary PAN;

means for said issuer contacting a system server to confirm the validity of said monetary transaction based on said temporary PAN; and

means for if said system server confirms the validity of said monetary transaction, informing said first party and said second party of the result of said transaction and reconciling the transfer of payment between said first party and said second party if the result is positive.

The present invention is further directed to a computer readable medium comprising instructions to implement the method of obtaining and utilizing a PAN.

### BRIEF DESCRIPTION OF THE DRAWINGS

For a better understanding of the present invention, and to show more clearly how it may be carried into effect, reference will now be made, by way of example, to the accompanying drawings which aid in understanding an embodiment of the present invention and in which:

FIG. 1 is a block diagram illustrating a system utilizing an embodiment of the present invention;

FIG. 2 is a block diagram of the components of a system server;

FIG. 3 is a block diagram of the components of a mobile client resident on a mobile wireless device;

FIG. 4 is a block diagram of the components of an application server;

FIG. 5 is a flowchart of the process for an system server obtaining a block of PANs;

FIG. 6 is a flowchart of the process for a user requesting a PAN;

FIGS. 7a and 7b are flowcharts of the process of using PAN for a purchase;

FIGS. 8a and 8b are flowcharts of the process of using a PAN to top up a third party account; and

FIG. 9 is a flowchart of the process of using a PAN for transferring tokens to a terminal.

### DETAILED DESCRIPTION OF EMBODIMENTS OF THE INVENTION

To aid the user in understanding the invention, we provide a few preliminary definitions:

i) PAN—Primary access number, an example being a number, such as a credit/debit card number, in this disclosure for the purpose of a monetary transaction, a PAN is a temporary PAN, in other words it is provided for a single monetary transaction, for a limited time.

ii) Mobile Wireless Device—an electronic device that communicates through a wireless protocol. Examples would be a Personal Digital Assistant (PDA) or a cell phone.

iii) Mobile Client—an application resident in a mobile wireless device that manages (among other things) obtaining and utilizing a PAN.

iv) User—the person registered with the system in possession of the mobile wireless device containing the mobile client.

v) CNP Merchant—a Card Not Present merchant, a seller of goods or services, which accepts transactions when a payment card is not physically present at the time of purchase.

vi) Smart Unattended Terminal—a device that obtains information from a mobile client through the use of Near Field Contact (NFC). An example would be an automated device that monitors entry and exit to a parking lot, or other type of vending device.

vii) Terminal server—a server connected to a smart unattended terminal for managing offers presented to the smart unattended terminal.

viii) Third party account—a prepaid account for a service such as a mobile phone bill which needs to be paid periodically or “topped-up”.

ix) System Server—a control system connecting users with merchants.

x) Issuer—an entity that provides PANs for distribution by the System Server.

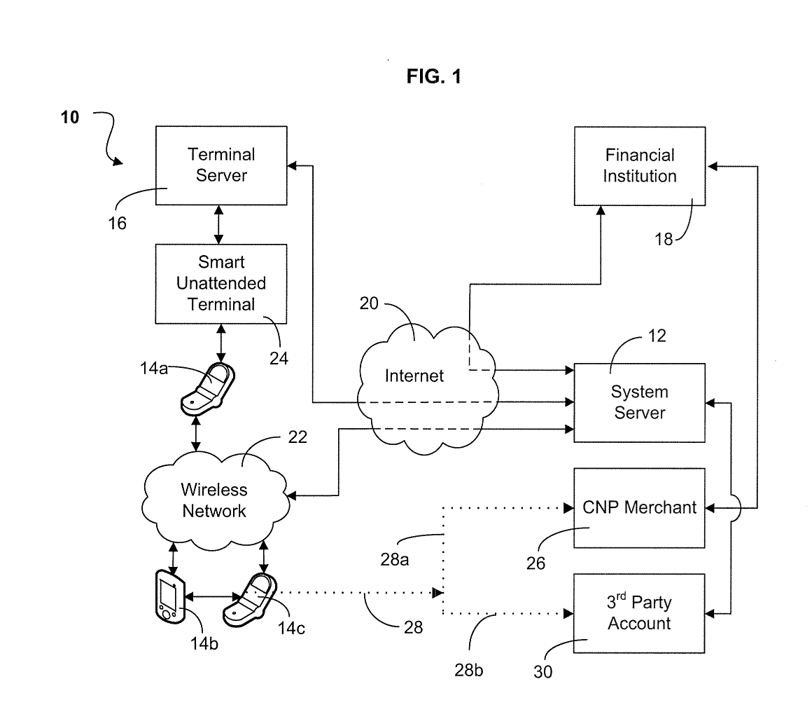

Referring to FIG. 1 a block diagram illustrating a system utilizing an embodiment of the present invention is shown generally as 10. At the heart of system 10 is a system server 12. The system server 12 interacts with mobile wireless devices 14a, 14b, 14c, terminal server 16, and financial institution 18 through a network 20 such as the Internet and a wireless network 22. Wireless network 22 may utilize formats of communication such as GPRS (General Packet Radio Service), CDMA (Code Divisional Multiple Access), UMTS (Universal Mobile Telecommunications System), infrared, Bluetooth, or Wi-Fi. Internet 20 and wireless network 22 serve only as examples of networks that may be utilized for communication between system server 12, and mobile wireless devices 14a, 14b, 14c.

System server 12 serves as the central control for system 10. It aids in reconciling transfers of funds between users and merchants. System server 12 is connected to a plurality of financial institutions 18 for the purpose of verifying and completing transactions.

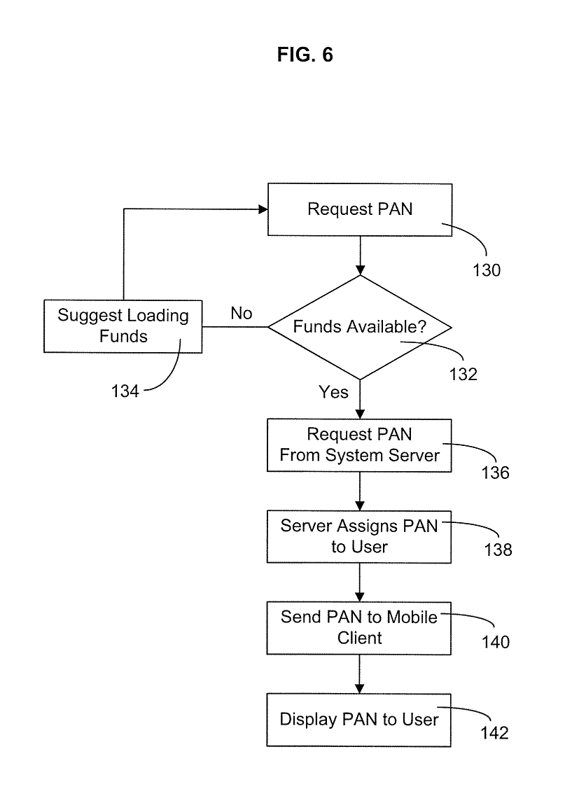

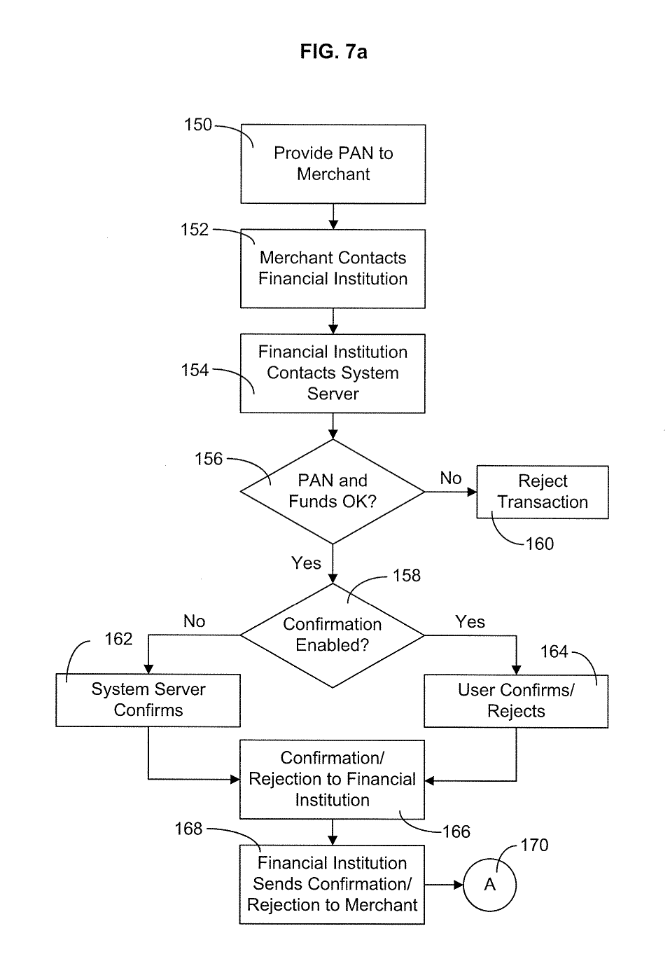

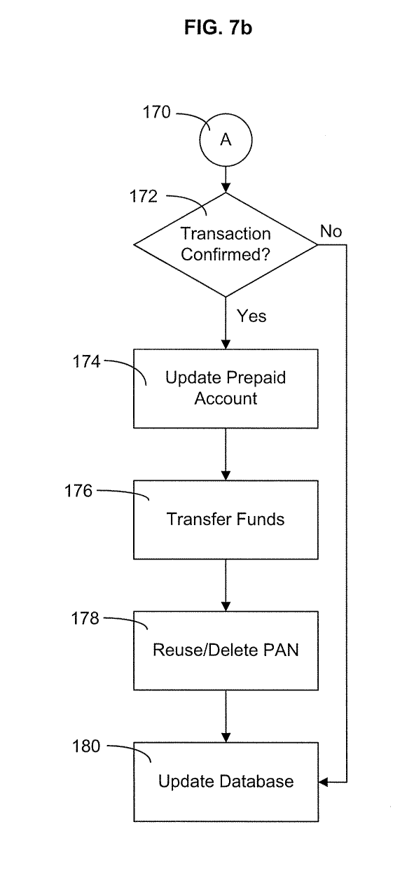

In one use of the present invention a user upon acquiring a PAN (see FIG. 6) may communicate the PAN to a CNP merchant 26 as shown by dotted lines 28 and 28a. In this situation the CNP merchant 26 would contact their financial institution 18 directly. Financial institution 18 would then contact system server 12 for verification of the PAN and the user account would be debited accordingly. This is described in more detail with reference to FIG. 7.

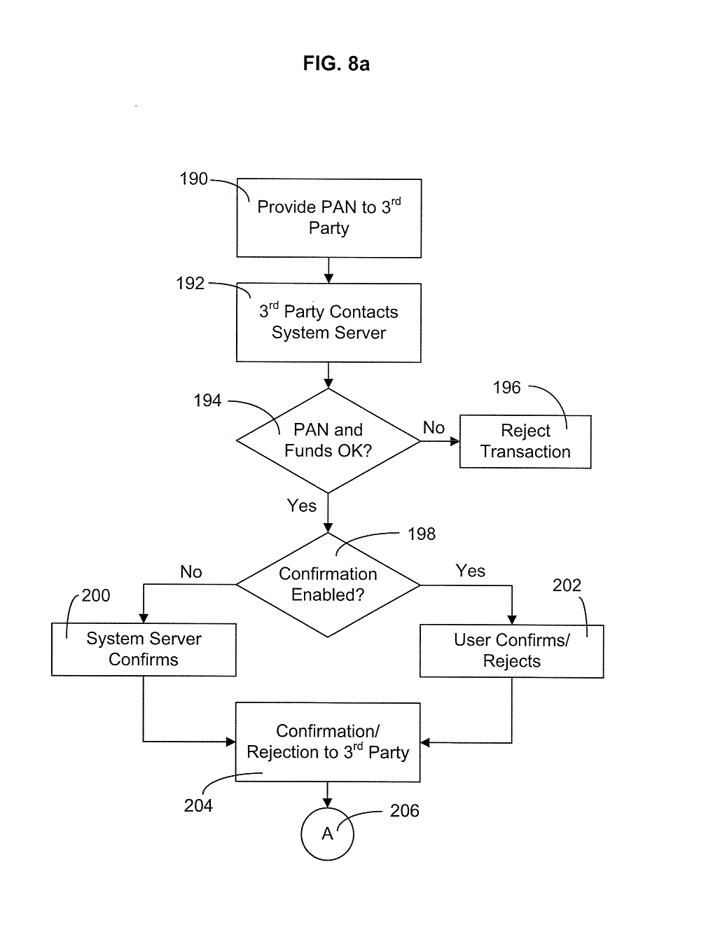

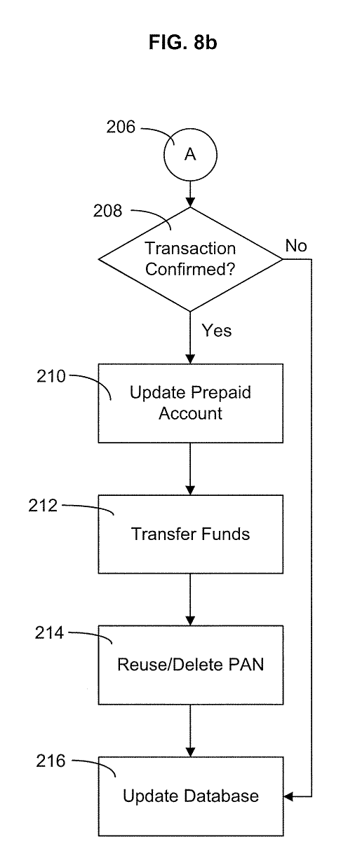

In another use of the present invention a user upon acquiring a PAN (see FIG. 6) may top up a third party account 30, such as their telephone usage account. This is shown by dotted lines 28 and 28b. In this case the PAN has been issued by the merchant providing the third party account and there is no need to contact the financial institution. This is described in more detail with reference to FIG. 8.

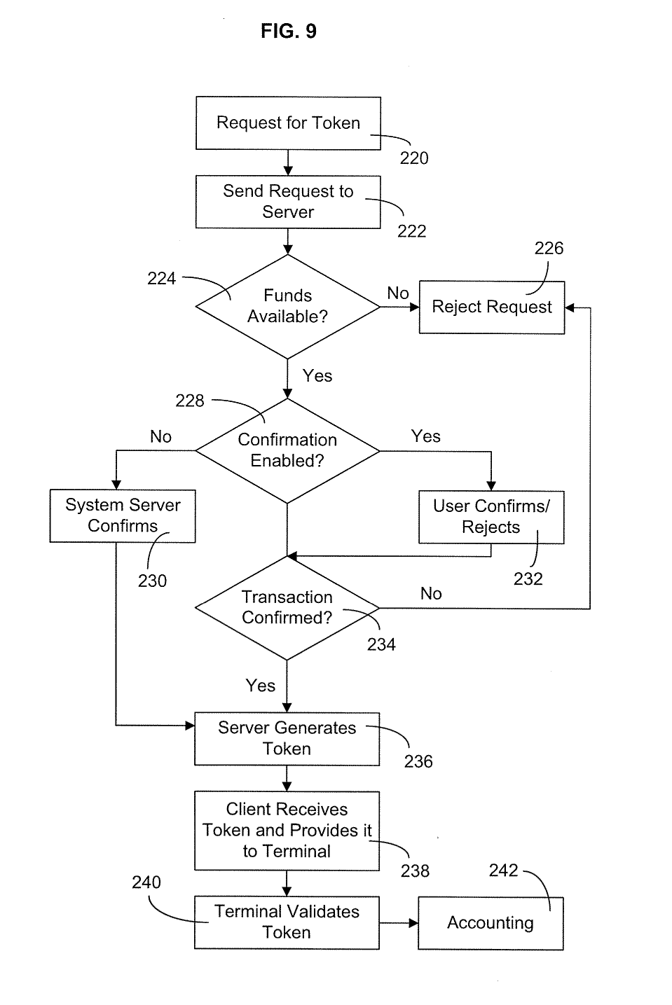

In another use of the present invention, a user of mobile wireless device 14a may make use of their mobile wireless device by bringing it within proximity of a smart unattended terminal 24 to communicate through the use of Near Field Communication (NFC). Smart unattended terminal 24 receives identification information from mobile wireless device 14a and recognizes it as a request to purchase an item, for example transportation token. In this case smart unattended terminal 24 then communicates with terminal server 16 which in turn sends to the system server 12 an offer to buy a token. The system server 12 then sends an offer to buy to the mobile client resident on mobile wireless device 14a. Upon confirmation of the transaction, the system server 12 sends the purchased token in a binary form to the mobile client resident on the mobile wireless device 14a and the mobile client transfers the token to the terminal 24. Terminal 24 validates the token with terminal server 16 which then informs smart unattended terminal 24 to let the user into the facility requiring a token. This is described in more detail with reference to FIG. 9.

In other use of the present invention terminal 24 sends an offer to purchase a token to the mobile wireless device 14a that is in proximity to the terminal 24 through the use of NFC. Optionally the mobile client resident on mobile wireless device 14a requests that the user confirm acceptance of the offer. The mobile client then connects to the system server 12 with the received offer. System server 12 creates a digital token and sends it to the mobile client, reconciling the funds. The mobile client provides the received token to the terminal 24 and upon validation of the token, terminal 24 accepts it, which in the case of the terminal 24 providing access to a gated entrance, permits entrance to the user. This is described in more detail with reference to FIG. 9.

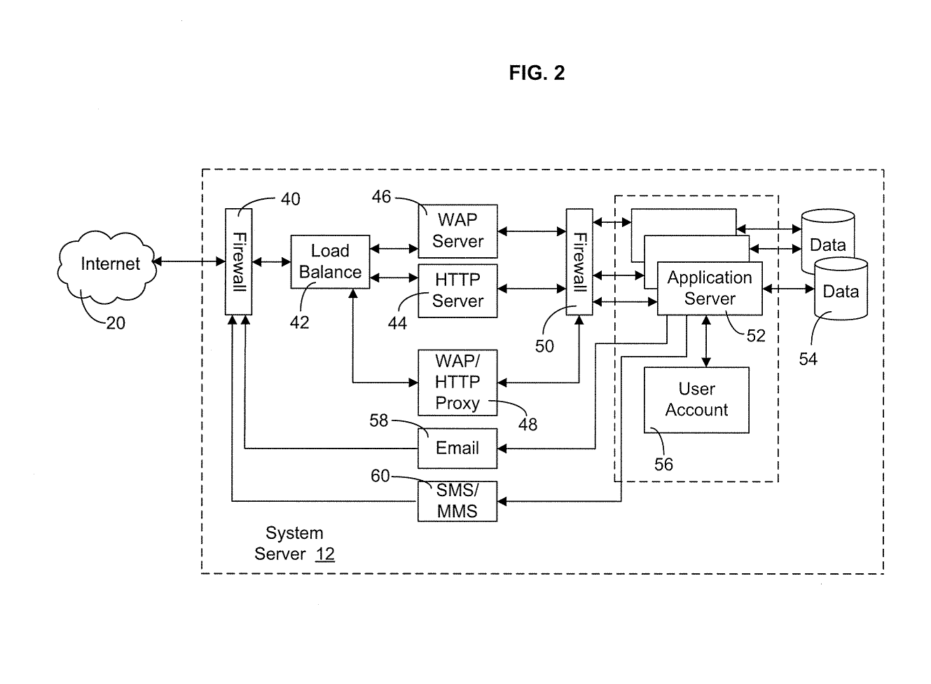

Referring now to FIG. 2 a block diagram of the components of the system server 12 is shown. Internet network 20 allows system server 12 to communicate with the other parts of the system 10. A firewall 40 is utilized to ensure network protection. An optional load balance module 42 may be utilized to balance communications traffic to a plurality of HyperText Transfer Protocol (HTTP) servers 44, Wireless Access Protocol (WAP) servers 46, and WAP/HTTP proxy servers 48. We refer to HTTP, as that is the protocol used for Internet communication. It is not the intent of the inventors to restrict the types of servers 44 and 48 to HTTP it simply serves as an example of one embodiment. A server 44, 46 or proxy 48 in turn communicates through a firewall 50 with an application server 52. An application server 52 handles transactions between users, merchants, terminal servers and financial institutions. An application server 52 is connected to one or more databases 54.

Database 54 contains information about users, such as their bank account numbers, their address, their phone number, their userid, their PIN, their cryptographic key, historical data on transactions, purchase confirmations and any other information that may be useful to application server 52.

User account 56 is an account that may be utilized by a user to store preloaded funds for a purchase utilizing a PAN. If there are insufficient funds in user account 56 for the use of a PAN the user will be required to add funds before the PAN will be issued.

Email module 58 is used by system server 12 to send email to a user who is not a registered user of the system. For example to send an invitation for a user to register.

SMS/MMS module 60 is used to send a message to a user who is not a registered user of the system or to wake up a mobile client on the mobile wireless device of a registered user if their mobile wireless device is inactive to inform them that their reply to a message from system server 12 is required.

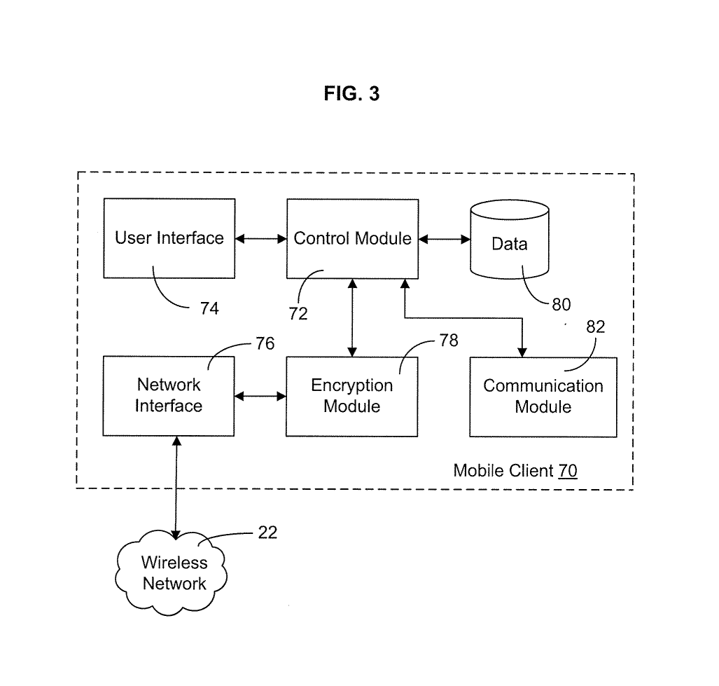

Referring now to FIG. 3 a block diagram of the structure of a mobile client resident on a mobile wireless device is shown. The functions of mobile client 70 are implemented in control module 72. Control module 72 interacts with user interface 74 to display information to a user on the mobile wireless device and receive input from a user. It also works with system server 12 to ensure that information exchanged between mobile client 70 and system server 12 are synchronized to keep both in the same state. For example expired offers are deleted and messages between the two are kept current. Network interface 76 provides the logic needed for the mobile wireless device to communicate with wireless network 22 via a protocol of choice. In communications with wireless network 22 network interface 76 makes use of an encryption module 78 for secure communication. Encryption module may make use of any number of data encryption schemes for example RSA, or the Advanced Encryption Standard (AES). In communication via wireless network 22 mobile client 70 utilizes a user cryptographic key stored in database 80 to confirm the identity of a user and to encrypt communications. A Personal Identification Number (PIN) is used to allow the user to access the functionality of the mobile client 70 and to confirm transactions.

Database 80 contains all the data required by the control module 72 to manage transactions and present the user with information on a transaction. Data may include: transaction history, a hash of the user PIN, the user cryptographic key, offers, User Interface display options and available funds.

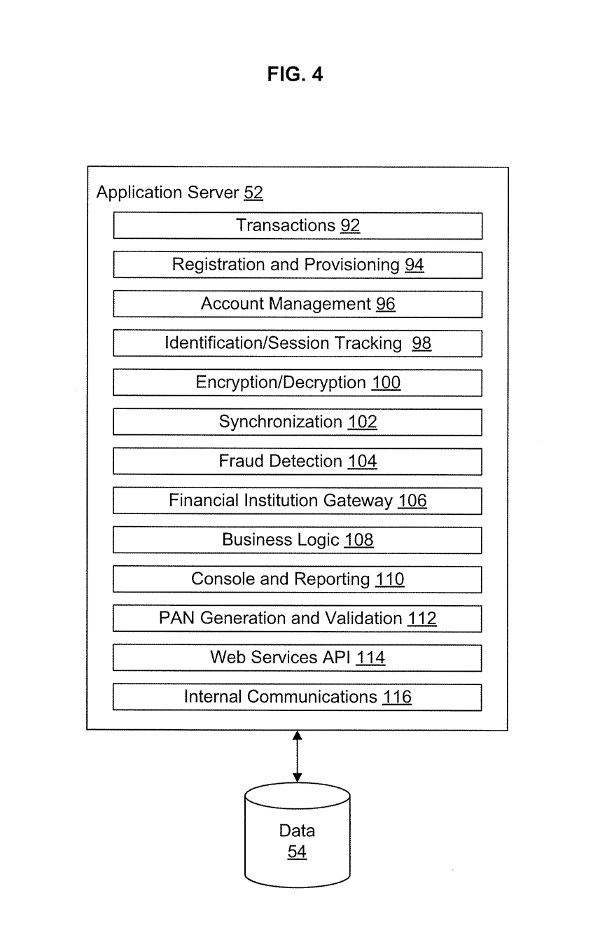

Referring now to FIG. 4 a block diagram of the components of an application server are shown. FIG. 4 illustrates the main components utilized to provide the functionality required in application server 52. Transactions component 92 handles the current transactions with each mobile client 70. Registration and provisioning component 94 handles the registration of users and provides them with a mobile client 70 to be installed on their mobile wireless device. Account management component 96 manages information on the financial accounts of users. Examples of financial accounts include user account 56 but may also include a checking account, credit card, or a debit card. Thus it is possible for a user to make a purchase based upon not only the money in their internal account but also to combine monies from other accounts with a financial institution 18. Account management component 96 tracks the money available in each account and reconciles the amounts owed with financial institution 18 after a purchase is made. In addition account management component 96 stores all transactions for a user in database 54. Optionally account management component 96 may also support a loyalty system, where loyalty points from transactions may be accumulated based on usage and redeemable by the user. Identification/Session tracking component 98 verifies the identification of a user of the system. Encryption/Decryption component 100 encrypts and decrypts messages to and from application server 52. Synchronization component 102 ensures that communications between the application server 52 and a mobile client 70 are kept synchronized, i.e. the state of communications sent between both should be identical. Fraud detection component 104 monitors for possible fraud.

Financial institution gateway component 106 provides the logic needed to communicate with a financial institution 18 in a financial industry standard manner. Business logic component 108 works with all other components to ensure the correct functioning of the application server 52 in that it acts as a general manager for the modules of application server 52. Console and reporting component 110 allows a system administrator for application server 52 to monitor traffic and generate reports on the communications handled by an application server 52. PAN Generation and Validation component 112 handles the generation and validation of PANs. Web services API 114 permits third parties to utilize the resources of application server 52 through the use of an API. Finally, internal communications component 116 handles the messages exchanged between a mobile client 70 and the application server 52.

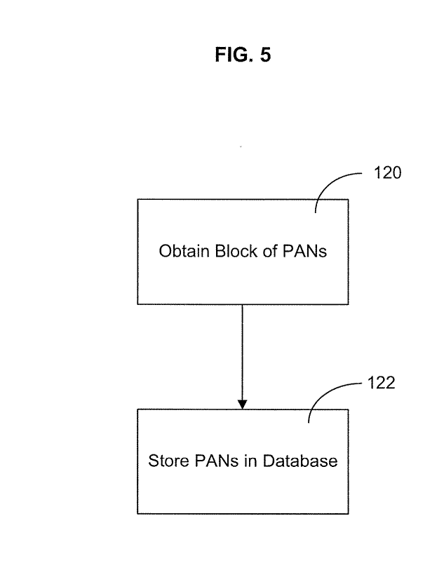

Referring now to FIG. 5 a flowchart of the process for a system server obtaining a block of PANs is shown. Before a user can obtain a PAN, system server 12 must have them on hand. Beginning at step 120 system server 12 obtains a block of PANs from financial institution 18 by renting or purchasing them. A PAN may be linked to a specific credit card brand so that a user requesting a PAN may obtain a branded PAN linked to a credit card brand accepted by the merchant they wish to make a purchase from. Optionally, system server 12 may also obtain PANs specific to a merchant from the CNP merchant 26 or the third party account 30. The PANs may map to a specific amount, for example $10 or $20, or may be available for dynamic assignment based upon the amount available in user account 56. Once PANs are issued they are stored at step 122 in database 54 for issuance to a user.

Referring now to FIG. 6 a flowchart of the process for a user requesting a PAN is shown. Beginning at step 130 a user requests a PAN from their mobile wireless device. At this point the user may request a branded PAN initially issued by a financial institution or a merchant specific PAN and also specify a dollar amount to be associated with the PAN. In addition a user may specify that the amount to be associated with a PAN is to come from one or more financial accounts. A PAN may be assigned to the user in any number of ways including randomly from the pool of available at that moment PANs from the issued block of PANs.

At step 132 a test is made to determine if the user has funds available for the transaction in a user account 56 with system server 12 (see FIG. 2). If no funds are available the user is advised at step 134 to load funds into the user account 56 and processing returns to step 130. If the user does have prepaid funds available processing moves to step 136 where a request is sent to system server 12 to provide a PAN. At step 138 system server 12 selects an appropriate PAN assigns it to a user. At step 140 the PAN is sent to the mobile client 70 of the user. At step 142 the PAN is displayed to the user on the mobile wireless device.

All communications described in FIG. 6 are encrypted through the use of cryptographic keys. Further, a session cryptographic key may be utilized by system server 12 at step 140 in communications with mobile client 70 for one time use to complete the issuance of a PAN.

Additional information such as an issue date or expiry date can also be provided along with the PAN. By default funds available to a PAN are equal to the amount in the user account 56.

Referring now to FIG. 7a a flowchart of the process of using a PAN for a purchase is shown. Beginning at step 150 a user provides the PAN to the CNP merchant 26 and other information as required. The merchant utilizes their existing infrastructure for credit or debit card purchases and at some point contacts the financial institution 18 that issued the PAN at step 152. The financial institution 18 recognizes the PAN as being issued to the system server 12 and sends the transaction to the system server 12 at step 154.

At step 156 the system server 12 checks that the PAN is valid, the user specified in the transaction has the PAN specified in the transaction assigned to the user and the funds associated with PAN are sufficient to complete the transaction. If this is the case processing moves to step 158 otherwise processing moves to step 160 where the transaction is rejected and the financial institution informed of this.

At step 158 a test is made to determine the type of confirmation required by the user. If the user does not wish to confirm the transaction processing moves to step 162 where the system server 12 confirms the transaction. If the user wishes to confirm the transaction processing moves to step 164 where the mobile client 70 of the user is asked to confirm or reject the transaction. Processing then moves to step 166 where the financial institution 18 is informed of the confirmation or rejection of the transaction. At step 168 the financial institution 18 then informs the merchant of the confirmation or rejection of the transaction. Transition is then made to FIG. 7b by connection point 170 to step 172.

At step 172 of FIG. 7b a test is made to determine if the transaction was confirmed. If not processing moves to step 180. If the transaction was confirmed processing moves to step 174 where the user account 56 is updated to reflect the amount of the transaction. At step 176 the amount of the transaction utilizing the PAN is transferred to the financial institution 18. At step 178 the PAN may either be returned to a pool of available PANs or alternatively deleted. At step 180 the outcome of the transaction is stored in database 54.

Referring now to FIG. 8a a flowchart of the process of using a PAN to top up a third party account is shown. In this case the PAN has been issued by a merchant and does not require confirmation with a financial institution. For example the PAN may be used to purchase more time from a mobile phone carrier by adding funds to third party account 30 by topping up a mobile phone carrier user account. In this case the process of obtaining a PAN is the same as shown with regard to the description of FIG. 6, however the method of using the PAN to top up the third party account is different.

In this case when a user utilizes a PAN with a third party, the third party connects directly to system server 12, bypassing financial institution 18. Beginning at step 190 a user provides the PAN to the third party 30 and other information as required. The third party then contacts system server 12 at step 192. At step 194 the system server 12 checks that the user specified in the transaction has the PAN specified in the transaction assigned to them and the funds associated with PAN are sufficient to complete the transaction. If this is the case processing moves to step 198 otherwise processing moves to step 196 where the transaction is rejected and the third party account informed of this.

Moving to step 198 a test is made to determine the type of confirmation required by the user. If the user does not wish to confirm the transaction processing moves to step 200 where the system server 12 confirms acceptance of the transaction. If the user wishes to confirm the transaction processing moves to step 202 where the mobile client 70 of the user is asked to confirm or reject the transaction. Processing then moves to step 204 where the third party 30 is informed of the confirmation or rejection of the transaction. Transition is then made to FIG. 8b by connection point 206 to step 208.

At step 208 of FIG. 8b a test is made to determine if the transaction was confirmed. If not processing moves to step 216. If so at step 210, the user account 56 is updated to reflect the amount of the transaction. At step 212 the amount of the transaction utilizing the PAN is transferred to the third party account 30. At step 214 the PAN may either be returned to a pool of available PANs or alternatively deleted. At step 216 the outcome of the transaction is stored in database 54.

In another scenario, when a user obtains a PAN with a predefined value the merchant need not contact the system server 12 for confirmation. The merchant is aware of the PAN provided and it can handle the transaction without the need of system server 12.

Referring now to FIG. 9 a flowchart of the process of using a PAN for transferring tokens to a terminal is shown. In this use, the user is attempting to pay for a transaction such as the purchase of a token to gain entry to a transit system. Beginning at step 220 a user has contacted a terminal 24 by Near Field Communication with their mobile wireless device 14a (see FIG. 1). This may be initiated by the terminal 24 or by the wireless mobile device 14a. The terminal 24 will then send a request to the mobile client 70 or to the terminal server 16 to receive the necessary token. In either case the request for a token will be sent to system server 12 at step 222. At step 224 system server 12 determines if the user has sufficient funds in their user account 56. If not processing moves to step 226 where the request is rejected and the mobile client 60 on mobile wireless device 14a and the terminal server 16 (if the request came from the sever 16) are informed. If funds are available processing moves to step 228 where a test is made to determine if the user of the mobile wireless device 14a has elected to confirm transactions. If this is the case processing moves to step 232 where the user may confirm or reject the transaction. At step 234 if the user at step 232 has confirmed the transaction processing moves to step 236 otherwise the request is rejected at step 226 as described above. Returning to step 228 if the user has requested that the system server 12 confirm the transaction, this is done at step 230 and processing moves to step 236. At step 236 the system server 12 assigns a PAN from the block of PANs issued by the merchant owning the terminal and returns it to the mobile client 70. At step 238 the mobile client 70 will then provide the PAN to the terminal 24. At step 240 the terminal 24 will then validate the PAN with terminal server 16. Once the PAN has been validated, the transaction is complete and in the case of a token, the user will be admitted. In the case of small transactions this may be all achieved automatically without requiring any input from the user. At step 242 the transaction is then stored in database 54, the account of the merchant credited and the user account 56 debited. In essence, a token is a PAN, a number for one time use as a token.

An additional feature that may be implemented in the present invention would be the ability to allow multiple users to use a single user account 56 for obtaining a PAN, for example by family members or corporation members.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method for obtaining and utilizing a PAN to conduct a monetary transaction between a first party and a second party through the use of a mobile wireless device comprising the steps of:
providing to said first party a temporary PAN from a block of PANs obtained from an issuer;
said first party providing said temporary PAN to said second party;
said second party contacting said issuer to verify said temporary PAN;
said issuer contacting a system server to confirm the validity of said monetary transaction based on said temporary PAN; and
if said system server confirms the validity of said monetary transaction, informing said first party and said second party of the result of said transaction and reconciling the transfer of payment between said first party and said second party if the result is positive.

2. The method of claim 1 further comprising the step of said system server confirming the validity of said transaction with said first party.

3. The method of claim 1 wherein the step of said second party contacting said issuer is omitted if said second party is an issuer.

4. The method of claim 1 further comprising the step of associating a value to said temporary PAN based upon funds available in a user account associated with said first party.

5. The method of claim 1 further comprising the step of associating a value in one or more financial accounts associated with said first party to said temporary PAN.

6. The method of claim 4 further comprising the step of permitting said first party to reduce the funds available to said temporary PAN.

7. The method of claim 1 further comprising the step of said system server recognizing a mobile client uniquely installed on said mobile wireless device identified by a cryptographic key associated with a user of said mobile wireless device.

8. The method of claim 1 wherein said step of said first party providing said temporary PAN to said second party includes presenting additional information said additional information including credit card brand information.

9. The method of claim 1 wherein the step of providing to said first party a temporary PAN further comprises the step of permitting said first party to select a credit card brand for said temporary PAN.

10. The method of claim 1 wherein said monetary transaction comprises the exchange of a token between said first party and said second party through NFC.

11. The method of claim 1 wherein said temporary PAN is provided randomly from a block of PANs.

12. The method of claim 1 wherein said temporary PAN is returned for reuse after the completion of said monetary transaction.

13. The method of claim 1 wherein said temporary PAN is deleted after the completion of said monetary transaction.

14. The method of claim 1 wherein second party is a card not present merchant.

15. The method of claim 1 further comprising the step of said first party accumulating loyalty points for monetary transactions, said loyalty points being redeemable by said first party.

16. The method of claim 1 further comprising the step of linking a group of users to a single user account.

17. The method of claim 1 further comprising the step of upon informing said first party, indicating this to said first party via sound or vibration through said mobile wireless device.

18. The method of claim 1 wherein said issuer may issue PANs having a predefined value.

19. The method of claim 3 wherein said issuer validates said temporary PAN.

20. A system for obtaining and utilizing a PAN to conduct a monetary transaction between a first party and a second party through the use of a mobile wireless device comprising:
means for providing to said first party a temporary PAN from a block of PANs obtained from an issuer;
means for said first party providing said temporary PAN to said second party;
means for said second party contacting said issuer to verify said temporary PAN;
means for said issuer contacting a system server to confirm the validity of said monetary transaction based on said temporary PAN; and
means for if said system server confirms the validity of said monetary transaction, informing said first party and said second party of the result of said transaction and reconciling the transfer of payment between said first party and said second party if the result is positive.

21. A computer readable medium comprising instructions to implement the method of claim 1.
